(19) United States
(12) Patent Application Publication
(10) Pub. No.: US 2015/0309583 A1
(43) Pub. Date: Oct. 29, 2015

(54) MOTION RECOGNIZING METHOD THROUGH MOTION PREDICTION

(71) Applicant: MEDIA INTERACTIVE INC., Guro-gu Seoul (KR)

(72) Inventors: Chang Joo Lim, Seoul (KR); Yun Guen Jeong, Gyeonggi-do (KR)

(21) Appl. No.: 14/647,882

(22) PCT Filed: Nov. 28, 2013
(86) PCT No.: PCT/KR2013/010893

§ 371 Date: May 28, 2015

(30) Foreign Application Priority Data
Nov. 28, 2012 (KR) 10-2012-0135850

(51) Int. Cl. G06F 3/01; G06F 3/00

(52) U.S. Cl. CPC G06F 3/017; G06F 3/005

(57) ABSTRACT

A motion recognition method is disclosed. The method includes the steps of: detecting a user's motion in real time by using a motion recognition sensor; predicting a motion pattern to be drawn by the detected motion by comparing the detected motion with pre-set pattern information, wherein the motion pattern includes information on a type of a figure to be drawn by the detected motion and an anticipated time of the detected motion to be completed; and executing a control function corresponding to the predicted type of figure at the time when the anticipated time lapses.

### FIELD OF THE INVENTION

The present invention relates to a method for recognizing a user's motion by using a motion recognition sensor.

### BACKGROUND OF THE INVENTION

Motion recognition in real time roughly undergoes processes of [(i) sensor recognition→(ii) transmission of video information→(iii) computation and processing→(iv) outputting through a display]. Due to the processes, a user's motion cannot be perfectly synchronized with a motion of an object which is rendered by referring to the user's motion and thus the satisfaction felt by the user may decline due to the delay time between the user's motion and the motion of the object. This may give bad influence over all contents, and particularly, it is an important issue in the sales of motion-based game contents.

### SUMMARY OF THE INVENTION

It is an object of the present invention to recognize a motion of a user by using a motion recognition sensor and compensate or correct time delay due to processes of recognizing the motion of the user.

In accordance with one aspect of the present invention, there is provided a motion recognition method, including the steps of: detecting a user's motion in real time by using a motion recognition sensor; predicting a motion pattern to be drawn by the detected motion by comparing the detected motion with pre-set pattern information, wherein the motion pattern includes information on a type of a figure to be drawn by the detected motion and an anticipated time of the detected motion to be completed; and executing a control function corresponding to the predicted type of figure at the time when the anticipated time lapses.

In accordance with one example embodiment of the present invention, the step of predicting the motion pattern includes the steps of: calculating a moving direction of the detected motion; and predicting the motion pattern to be drawn by the detected motion by comparing the calculated moving direction with the pre-set pattern information.

In accordance with one example embodiment of the present invention, the step of predicting the motion pattern includes the steps of: dividing the detected motion into several sections on the basis of a pre-fixed time interval and extracting vector components of the detected motion by the respective sections; and predicting the motion pattern to be drawn by the detected motion by comparing the extracted vector components by the respective sections with the pre-set pattern information.

In accordance with one example embodiment of the present invention, the vector components corresponds to acceleration of the detected motion.

In accordance with one example embodiment of the present invention, the step of updating the pattern information based on the detected motion whenever the control function is executed is further included.

In accordance with one example embodiment of the present invention, the step of determining an identity of the user if a motion recognition mode is executed to detect the user's motion is further included and wherein the pre-set pattern information is different by each user.

In accordance with one example embodiment of the present invention, the step of executing a tutorial mode to create pattern information if the identity of the user is determined to be a new user is further included.

In accordance with one example embodiment of the present invention, a different control function is executed depending on the predicted type of the figure.

In accordance with one example embodiment of the present invention, the motion recognition sensor is a motion recognition camera capable of capturing a movement of an object and recognizing a motion from the captured movement.

In accordance with one example embodiment of the present invention, the control function is a function of varying at least one of a size, a position, a color, and a shape of an object displayed through a display unit.

### BRIEF DESCRIPTION OF THE DRAWINGS

The above and other objects and features of the present invention will become apparent from the following description of preferred embodiments given in conjunction with the accompanying drawings, in which:

FIG. 1 is a concept diagram illustrating a conventional motion recognition system.

FIG. 2 is a diagram for explaining one example of time delay occurring at the conventional motion recognition system of FIG. 1.

FIG. 3 is a drawing showing exemplary motion patterns that may be inputted by a user.

FIG. 4 is a concept diagram for explaining a motion recognition method in accordance with one example embodiment of the present invention.

FIG. 5 is a drawing for explaining a method for predicting a motion pattern by referring to a motion trajectory in accordance with one example embodiment of the present invention.

FIG. 6 is a diagram for explaining a method for predicting a motion pattern by referring to an acceleration pattern by respective sections in the motion trajectory in accordance with one example embodiment of the present invention.

FIG. 7 is a drawing for illustrating the acceleration pattern by the respective sections as explained in FIG. 6.

FIG. 8 is a drawing showing same gestures inputted by a plurality of users expressed in different ways in accordance with one example embodiment of the present invention.

FIG. 9 is a flowchart for explaining a flow of the motion recognition method in accordance with one example embodiment of the present invention.

FIG. 10 is a drawing for explaining a method for predicting the user's motion by referring to motion size, motion direction, and motion acceleration in accordance with one example embodiment of the present invention.

### DETAILED DESCRIPTION OF THE PREFERRED EMBODIMENTS

The example embodiments published in this specification will be explained in details by referring to the attached drawings. Regardless of drawing signs, the same or similar components will have same reference numbers and redundant explanation thereon will be omitted. “Module” and “part” as names of components below are given in consideration of only the easiness to prepare the specification or used mixed with each other but they do not have different meanings or roles themselves. Besides, if the detailed explanation on the relevant prior art is judged to disperse the summary of the example embodiment disclosed in the specification, the detailed explanation thereon will be omitted. In addition, it must be noted that the attached drawings are provided only to make the example embodiments understood more easily and they cannot be interpreted to limit the technical ideas disclosed herein.

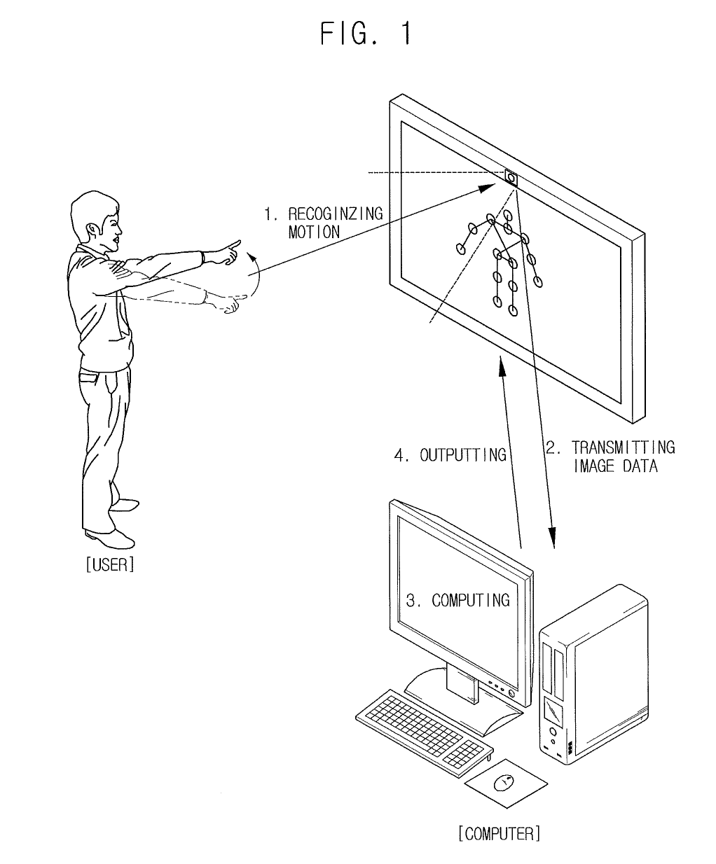

FIG. 1 is a concept diagram illustrating a conventional motion recognition system.

By referring to FIG. 1, according to a conventional motion recognition system, motion recognition in real time roughly undergoes processes of [(i) sensor recognition→(ii) transmission of video information→(iii) computation and processing→(iv) outputting through a display]. Due to the processes, a user's motion cannot be perfectly synchronized with a motion of an object which is rendered based on the user's motion and therefore the satisfaction felt by the user may decline due to the delay time between the user's motion and the motion of the object. This may give bad influence over all contents, and particularly, it is an important issue in the sales of motion-based game contents.

According to the conventional motion recognition system, when a user played a drum in real time in a rhythm game capable of recognizing the user's motion, for example, positions of both hands were recognized in two-dimensional plane coordinates, and thus, when a hand or pointer of the user entered into a pre-determined space zone, the sound of the drum corresponding to the entered zone was produced. According to the conventional method, time delay cannot but occur between the user's motion and outputting the sound of the drum due to internal processes. In addition, since only the pre-determined space zone was used during the rhythm game, it cannot consider various motion habits of various users. Thus, only inconvenient use interface was provided according to the conventional motion recognition system.

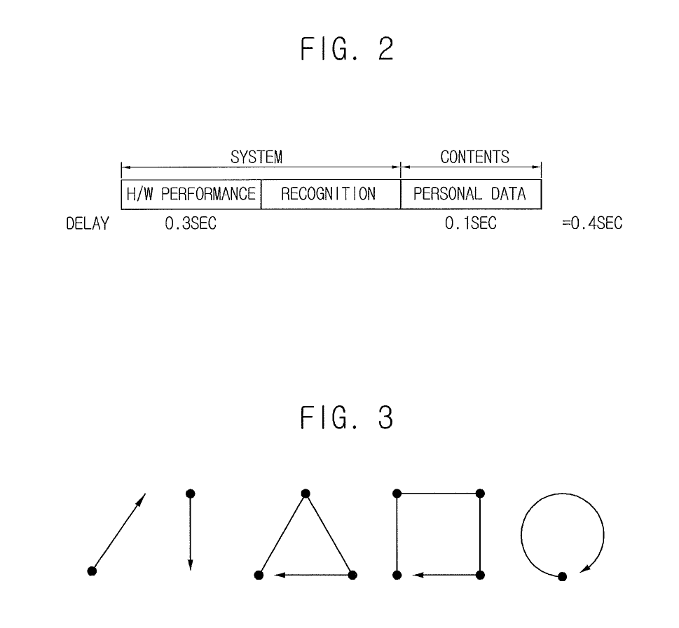

According to the conventional motion recognition system, as illustrated in FIG. 2, it takes a delay time of 0.3 seconds to recognize a motion and additional delay time of 0.1 second to perform the control function based on the recognized motion. Therefore, the total time delay of 0.4 seconds occurs.

To solve the delay problem, a motion recognition method in accordance with the present invention reflects the user's personal characteristics. For instance, it may collect the user's motion habit by monitoring at least one of a size (i.e., a range), a direction, and an acceleration of at least one motion, and optimize a method for manipulating a controller (i.e., control position, recognition rate, etc. of the motions) by using the collected patterns. By predicting the user's motions with the collected patterns, it is possible to improve reaction speed and compensate or correct time delay.

As a method for correcting the time delay, the motion recognition method in accordance with the present invention predicts and reflects future motions from the user's motion data. For example, it may predict the user's motion by putting weight on the recent data by using interpolation, etc. and adjusting coefficients. Because it executes the control function based on the predicted motions, it may reduce the delay time more than the conventional method.

The control function may be a function of varying at least one of a size, a position, a color, or a shape of an object to be displayed. The object means a graphic element of an application icon, a widget, a thumbnail image, etc.

FIG. 3 is an illustration drawing showing motion patterns that may be inputted by a user.

By referring to FIG. 3, examples of motions to execute the control function are illustrated. There may include a motion of moving straightly from a first to a second point, or a motion of forming a special figure such as a circle, a polygon, or a star.

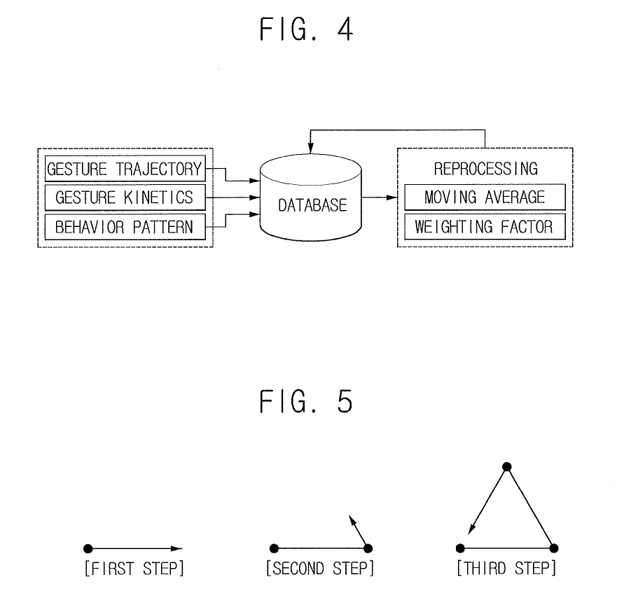

FIG. 4 is a concept diagram for explaining a motion recognition method in accordance with one example embodiment of the present invention.

By referring to FIG. 4, the motion recognition method in accordance with the present invention may predict the user's motion by dividing the user's motion, i.e., a motion trajectory, into several sections on the basis of a predetermined time interval and analyzing the respective sections of the motion trajectory. This may be called as a “gesture trajectory” prediction. Besides, it may predict the user's motion by dividing the user's motion into several sections based on a predetermine time interval and analyzing the acceleration pattern of the respective sections. This may be called as a “gesture kinetics” prediction. In addition, it may set user's pattern information relating to an order, a direction, and a size of drawing a figure and predict the user's motion by using the set pattern information. This may be called as a “behavior pattern” prediction.

Whenever the user's motion is detected, the characteristics of the detected motion are extracted and stored on a database. As the stored information is accumulated, an average value of the motion is accumulated and a coefficient of a weighted value is adjusted. This may allow user-customized user interface to be provided.

FIG. 5 is a drawing for explaining a method for predicting a motion pattern by referring to a motion trajectory in accordance with one example embodiment of the present invention.

In accordance with the present invention, the user's motion, first of all, is detected. In detail, whether the motion is a straight line or a curved one may be determined. If it is a straight line, whether the direction of the movement is changed or not is detected. If the movement is determined to be changed, a straight line is excluded as a prediction result and instead a figure, e.g., triangle, square, etc., to be drawn by the user's motion may be predicted. Based on the direction of the movement, a type of a figure to be drawn by the user's motion and an anticipated time of the user's motion to be completed may be predicted.

For example, as illustrated in FIG. 5, if the direction of the movement is changed twice and the direction of the secondly changed movement is toward the initial position where the motion has started, a figure to be formed by the user's motion may be predicted to be a triangle and the anticipated time of drawing the triangle may be calculated. In accordance with the present invention, a specific control function which corresponds to the predicted type of figure, i.e., the triangle, may be selected among various control functions and the selected specific control function may be executed at the time when the anticipated time lapses. This allows a time of recognizing the user's motion to be synchronized with a time of executing the control function corresponding to the recognized motion.

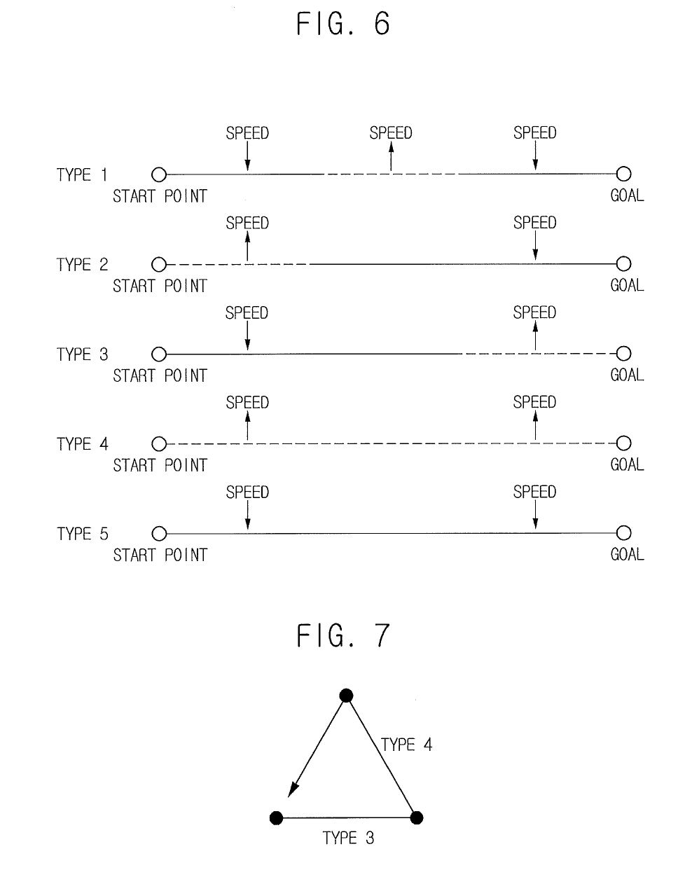

FIG. 6 is a diagram for explaining a method for predicting a motion pattern by referring to an acceleration pattern by respective sections in the motion trajectory in accordance with one example embodiment of the present invention.

In accordance with the present invention, a motion is detected, first of all. The motion is divided into several sections on the basis of a pre-fixed time interval and vector information is extracted by analyzing the several sections. For example, the vector information may include a speed, an acceleration, etc. By comparing the vector information calculated by the respective sections with pattern information stored in the memory, the user's motion may be predicted.

For instance, as illustrated in FIG. 6, while information on five patterns is stored in the memory, if the speed of the user's motion is detected to be “high→low→high” during a reference time from a start point to an end point, i.e., a goal, it may be predicted that the motion of “Type 1” is going to be inputted at the time when the speed changes from “low” to “high”. If the anticipated time when the user's motion arrives the end point lapses, a function corresponding to the “Type 1” may be executed.

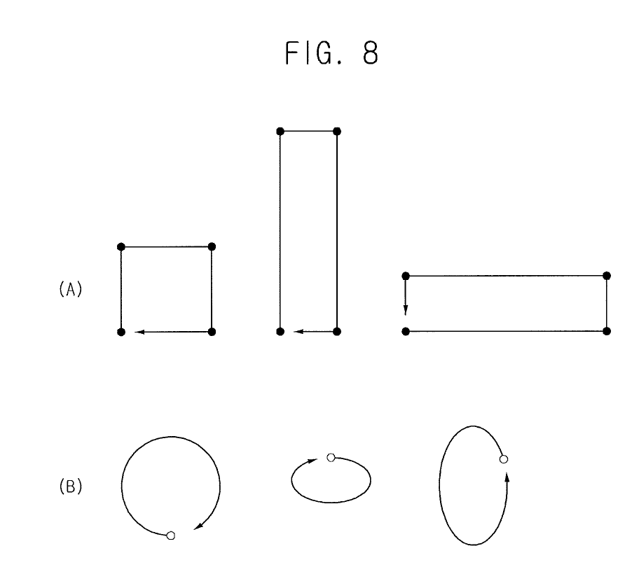

For another example, as illustrated in FIG. 7, by referring to information on five patterns stored in the memory, a motion at a straight line from left to right is determined to be “Type 3” and a motion at a straight line from down to up is determined to be “Type 4.” Then, if the motion at a straight line from up to down is detected, the user's motion may predict a figure to be a triangle and an anticipated time of drawing the triangular to be completed may be calculated.

Since the pattern information is updated whenever the user's motion is detected, the user's habit may be reflected appropriately. In other words, the type of the motion and the time of the motion to be completed may be estimated more accurately because the pattern information customized by respective users may be created.

FIG. 8 is a drawing showing same gestures inputted by a plurality of users expressed in different ways in accordance with one example embodiment of the present invention.

Even if the respective users intend to draw a same figure, the characteristics of the motions of the respective users may be different from each other. If the system learns the characteristics of the motions of the respective users, the system can predict the types of the motions and the time of the motions to be completed more accurately. For example, the characteristics of the motions may include orders of drawing figures, sizes of figures, etc.

For instance, as illustrated in FIG. 8, each of the users may draw a square in a different way. In detail, the position of a first point, i.e., a reference point of a square, and a direction of making the square may be different, and a length of each side of the square may be different. Such pattern information may be pre-set by the respective users and updated whenever the motions of the respective users are detected.

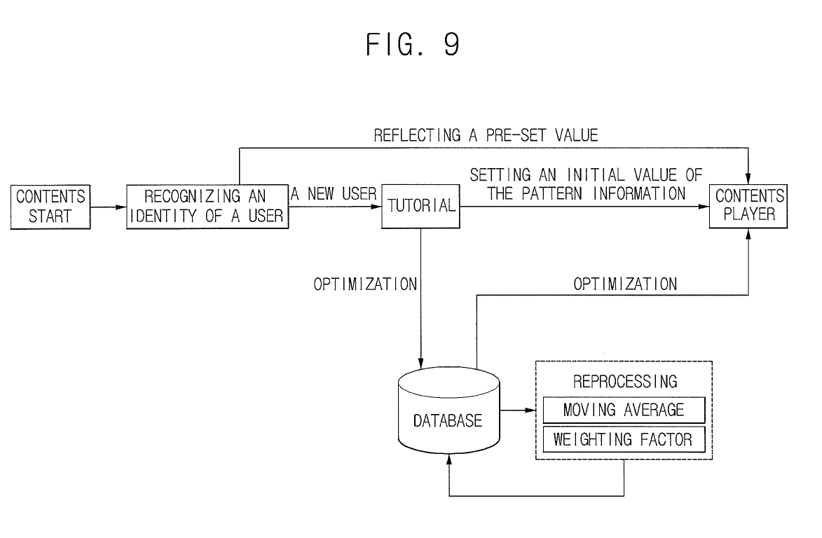

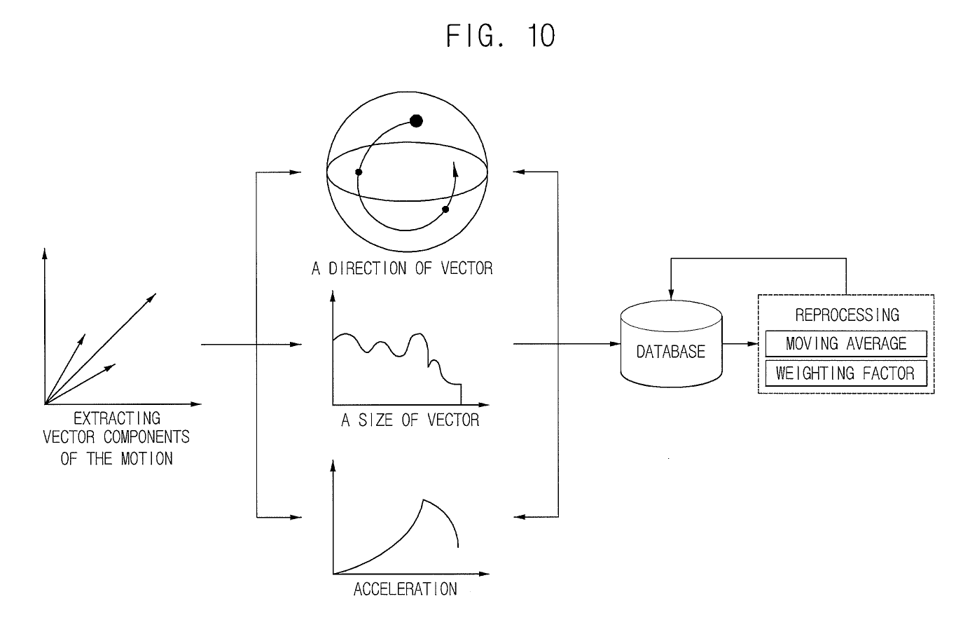

FIG. 9 is a flowchart for explaining a flow of the motion recognition method in accordance with one example embodiment of the present invention.

When a motion recognition mode is executed, who is a user, first of all, is determined. It is because the system forms different pattern information by each user. If a new user whose pre-specified data do not exist is considered, a tutorial mode is executed and a motion of the new user is inputted during the tutorial mode. Based on the inputted motion, an initial value of the pattern information may be set. Then, the pattern information is updated and optimized based on the motion subsequently inputted by the user.

If an existing user whose pattern information has already been stored is considered, the motion is predicted and recognized based on the stored pattern information. Based on the recognized motion, the control function may be executed.

As shown above, in accordance with the present invention, the type of the motion and the time of the motion to be completed may be predicted based on the pre-set pattern information. This may dramatically reduce time delay due to processes of motion recognition because the control function is going to be executed simultaneously when the user's motion is completed.

In accordance with one example embodiment described in this specification, it is possible as the pre-stated method to implement as a code which the processor may read as a program recorded medium. As examples of processor-readable media, there are ROM, RAM, CD-ROM, magnetic tape, flopical disk, optical data storage, etc. and those implemented in a form of carrier wave, e.g., transmission through the Internet, is also included.

In case of the motion recognition method explained as shown above, the configurations and methods of the explained embodiment examples as described above cannot be applied limitedly but all or part of the embodiment examples may be selectively combined to make a variety of transformations.

FIG. 10 is a drawing for explaining a method for predicting the user's motion by referring to motion size, motion direction, and motion acceleration in accordance with one example embodiment of the present invention.

The gesture trajectory, the gesture kinetics, and the behavior pattern as explained above by referring to FIGS. 5 to 8 are the methods for performing optimized prediction based on the pre-set motion patterns and they may use Kalman filter and particle filter algorithms. In accordance with the present invention, the motion recognition method may predict the user's motion by using at least one of the gesture trajectory, the gesture kinetics, and the behavior pattern. In such a method, it is possible not only to provide the optimized motion recognition technology to each user but also to shorten the delay time of the motion recognition to thereby improve the reaction speed.

The example embodiments of the present invention may be applied in a variety of related industrial fields by suggesting the motion recognition method for using motion prediction.

In accordance with the present invention, a type of the motion and a time of the motion to be completed may be predicted based on the pre-stored pattern information. This may reduce the time delay due to the processes of the motion recognition because the relevant control function is going to be executed at the same time when a user's motion is completed.

What is claimed is:

1. A motion recognition method, comprising the steps of:
detecting a user's motion in real time by using a motion recognition sensor;
predicting a motion pattern to be drawn by the detected motion by comparing the detected motion with pre-set pattern information, wherein the motion pattern includes information on a type of a figure to be drawn by the detected motion and an anticipated time of the detected motion to be completed; and
executing a control function corresponding to the predicted type of figure at the time when the anticipated time lapses.

2. The method of claim 1, wherein the step of predicting the motion pattern includes the steps of:
calculating a moving direction of the detected motion; and
predicting the motion pattern to be drawn by the detected motion by comparing the calculated moving direction with the pre-set pattern information.

3. The method of claim 1, wherein the step of predicting the motion pattern includes the steps of:
dividing the detected motion into several sections on the basis of a pre-fixed time interval and extracting vector components of the detected motion by the respective sections; and
predicting the motion pattern to be drawn by the detected motion by comparing the extracted vector components by the respective sections with the pre-set pattern information.

4. The method of claim 3, wherein the vector components corresponds to acceleration of the detected motion.

5. The method of claim 1, further comprising the step of: updating the pattern information based on the detected motion whenever the control function is executed.

6. The method of claim 1, further comprising the step of: determining an identity of the user if a motion recognition mode is executed to detect the user's motion;
wherein the pre-set pattern information is different by each user.

7. The method of claim 6, further comprising the step of: executing a tutorial mode to create pattern information if the identity of the user is determined to be a new user.

8. The method of claim 1, wherein a different control function is executed depending on the predicted type of the figure.

9. The method of claim 1, wherein the motion recognition sensor is a motion recognition camera capable of capturing a movement of an object and recognizing a motion from the captured movement.

10. The method of claim 1, wherein the control function is a function of varying at least one of a size, a position, a color, and a shape of an object displayed through a display unit.
